(19) United States
(12) Patent Application Publication
(10) Pub. No.: US 2014/0306796 A1
(43) Pub. Date: Oct. 16, 2014

(54) Circuitry Apparatus

(71) Applicant: Bryan Buenaventura, Hayward, CA (US)

(72) Inventor: Bryan Buenaventura, Hayward, CA (US)

(21) Appl. No.: 13/861,087

(22) Filed: Apr. 11, 2013

(51) Int. Cl. H01C 13/02

(52) U.S. Cl. CPC H01C 13/02
USPC 338/320

(57) ABSTRACT

An apparatus for easing installation of electronic devices. A plurality of resistors and wires in various configurations and values join to form a unitary circuit. The unitary circuit includes a predetermined Ohm value, or other electrical value. The unitary circuit allows for facilitated installation onto additional circuits, such as security system. A first resistor and a second resistor join in series-parallel or parallel-series to each other. The first resistor joins to a first black wire and a first gray wire. The second resistor joins to a first black wire, a second black wire, and a second gray wire. The components are twist tied together and joined with shrink tube, hard tube, and finally labeled shrink tube. This forms a prepackaged bundle of electrical components with labeled resistor values. The first resistor and second resistor each have a value of 1 kilohm or 2 kiliohms.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to electronic wiring. More particularly, the invention relates to electronic wiring in monitoring systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

There are some notable limits in the available installation equipment options that are available to technicians. These limits are in the form of installation tools or products that could aid in helping technicians accomplish work faster and with higher quality.

One known solution shows a security system that can be retrofit with existing equipment in the field, where the system, upon connection to end-of-line resistors, automatically reads and calibrates itself to function with the various resistors already installed. Another known solution teaches of a plurality of protective resistors that can be easily inserted between circuit forming elements, and opposite ends of each protective resistor can be properly press-contacted to each circuit forming element. Yet another known solution discloses of an electronic circuit package in which a resistor network is readily installed and remains accessible for laser trimming after final assembly of the package. However, none of these solutions provide resistors in an effective, easy-to-use form.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an apparatus for easing installation of electronic devices, in accordance with an embodiment of the present invention;

FIG. 2 is an illustration of a connection area between sets of wires, in accordance with an embodiment of the present invention;

FIG. 3 is an illustration of a schematic diagram of a circuit, in accordance with an embodiment of the present invention;

FIG. 4 is an illustration of a method for making an apparatus for easing installation of electronic devices, in accordance with an embodiment of the present invention; and

FIG. 5 is an illustration of a method for using an apparatus for easing installation of electronic devices, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Embodiments of the present invention provide means and methods for easing the installation of electronic devices.

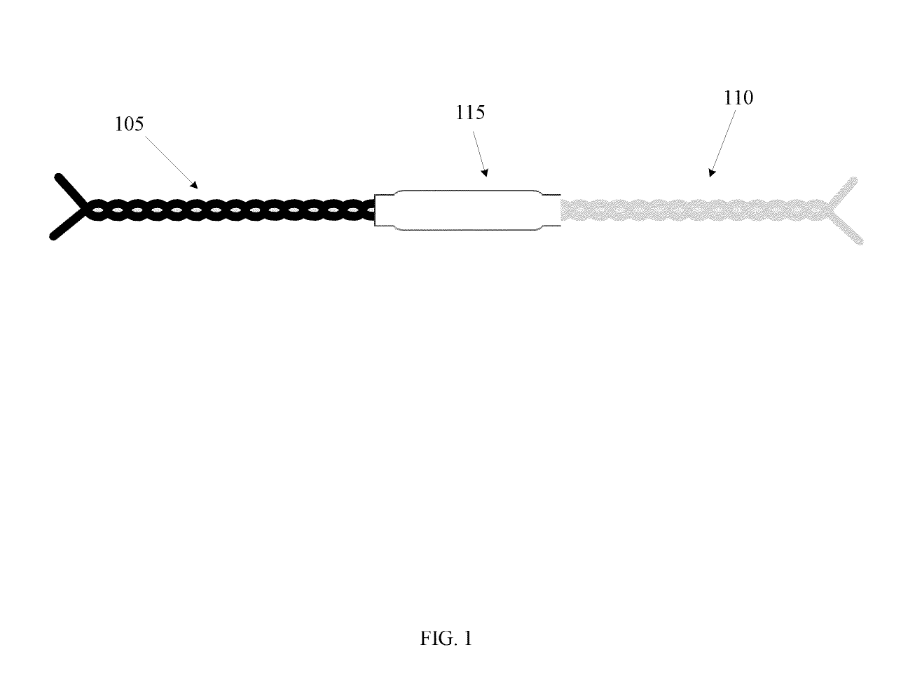

FIG. 1 is an illustration of an apparatus for easing installation of electronic devices, in accordance with an embodiment of the present invention. In the present embodiment, a first set of wires 105 may be connected to a second set of wires 110. In alternative embodiments, any number of sets of wires may be used. In some embodiments, wires may be insulated. In the present embodiment, each set of wires may be composed of two individual wires twisted together. In alternative embodiments, sets of wires may be composed of individual wires which may not be twisted together. In other alternative embodiments, each set of wires may be composed of any number of individual wires. In many embodiments, the first set of wires 105 may be composed of black wires and the second set of wires 110 may be composed of white wires so that a user may easily distinguish between sets of wires. In alternative embodiment, sets of wires may be composed of wires of any colors. In the present embodiment, a tube 115 may cover a connection between sets of wires.

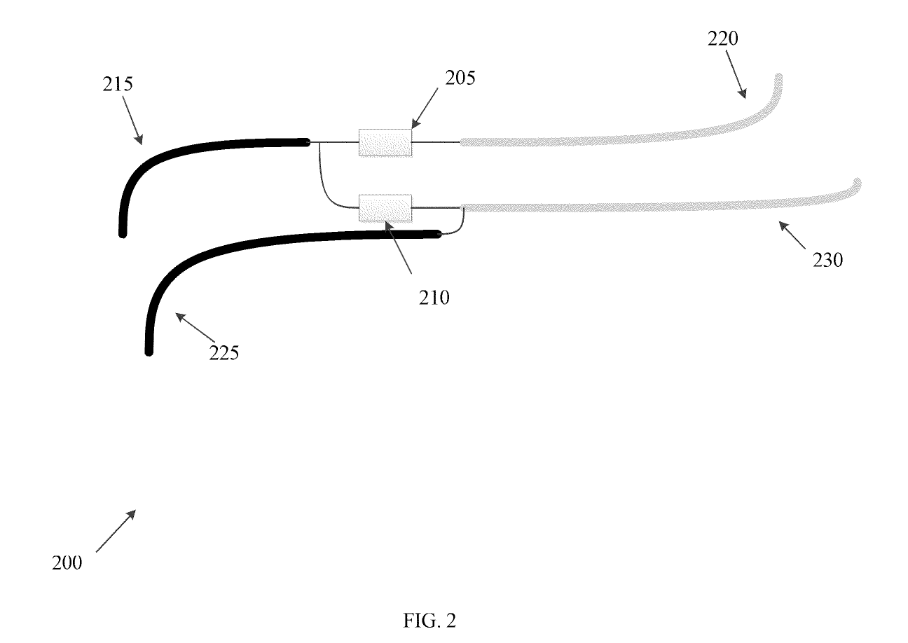

FIG. 2 is an illustration of a connection area between sets of wires, in accordance with an embodiment of the present invention, a plurality of resistors and wires in various configurations and values may be joined to form a unitary circuit 200. In this manner, the unitary circuit may provide a prepackaged circuit with a specific Ohm value for facilitated installation into a monitoring system. In some embodiments, a first resistor 205 and a second resistor 210 may be connected in series-parallel or parallel-series to each other. In the present non-limiting example, the first resistor 205 may be connected to a first black wire 215 and a first gray wire 220. The second resistor 210 may be connected to the first black wire 215, a second black wire 225, and a second gray wire 230. As a non-limiting example, the first resistor 205 and second resistor 210 may each have a value of 1K Ohms. In other embodiments, resistors may have various values so as to meet standards for numerous types of electronic devices and systems. In alternative embodiments, one, three, or more resistors may be used in a connection.

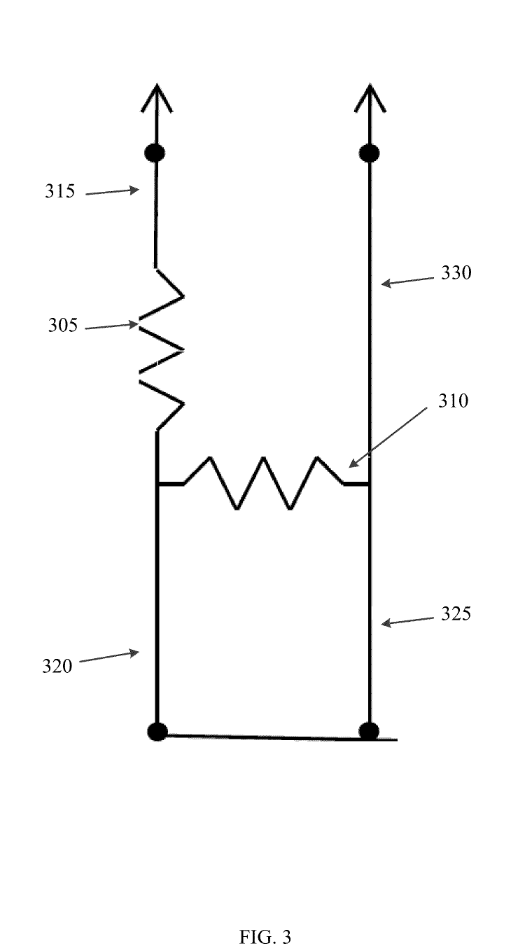

FIG. 3 is an illustration of a schematic diagram of a circuit, in accordance with an embodiment of the present invention. A first resistor symbol 305 may represent the first resistor 205. A second resistor symbol 310 may represent the second resistor 210. A first wire symbol 315 may represent the first gray wire 220. A second wire symbol 320 may represent the second gray wire 230. A third wire symbol 325 may represent the first black wire 215. A fourth wire symbol 330 may represent the second black wire 225.

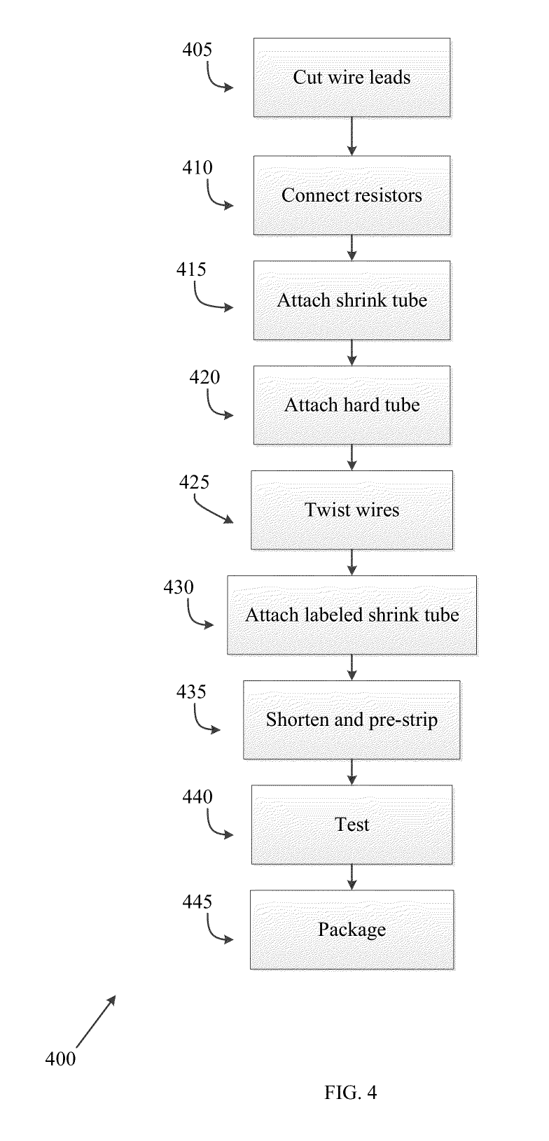

FIG. 4 is an illustration of a method for making an apparatus for easing installation of electronic devices, in accordance with an embodiment of the present invention. In the present embodiment, a method 400 may require a sequence of steps and manipulations to wires and resistors, and other electrical components to form a prepackaged circuitry having a predetermined Ohm value. In some embodiments, wire leads may be cut in a step 405. In some embodiments, two black wires and two white wires may be cut. In a non-limiting example, each wire may be approximately six inches in length. In alternative embodiments, wires may be of any length. In the present embodiment, resistors may be connected to the wires in a step 410. In some embodiments, two resistors may be connected to the wires through use of a soldering iron. Any extra trimmings from wires or resistors may be cut. In the present embodiment, a shrink tube may be applied so as to cover the resistors and any connecting ends of the wires in a step 415. In some embodiments, a heat shrink tube may be used. In many embodiments, a heat gun may be used to shrink the heat shrink tube so as to attach it to the wires and resistors. In a non-limiting example, the heat shrink tube may be 3/32″×¾″ inch in size. In some other embodiments, the resistors and wires may be dipped into hot-melt glue cylinders instead of using a heat shrink tube. In the present embodiment, a hard tube may be applied to cover the shrink tube in a step 420. In a non-limiting example, the hard tube may be 9/8″×¼″ inch in size. In the some embodiments, adhesive silicone may be applied between the shrink tube and the hard tube and be given the necessary time to dry. In a non-limiting example, an appropriate drying time may be overnight. In alternative embodiments, any adhesive substance may be used. In the present embodiment, two or more wires may be twisted together in a step 425. In some embodiments, the two black wires may be twisted together and the two white wires may be twisted together. In many embodiments, a drill may be used to twist the wires. In the present embodiment, a labeled shrink tube may be applied over the hard tube in a step 430. In a non-limiting example, the labeled shrink tube may be ¼″× 3/2″ inches in size. In some embodiments, the labeled shrink tube may be centered to the hard tube and a heat gun may be used to secure the labeled shrink tube to the hard tube. In many embodiments, any labels may be positioned to face in a uniform direction. In alternative embodiments, labels may face in any direction. In the present embodiment, any wires may be shortened and/or any wires may be pre-stripped in a step 435. In some embodiments, wires may be shortened and/or pre-stripped through use of a stripping tool or any other means. In a non-limiting example, wires may be shortened to a length of approximately four inches. In the present embodiment, a circuit may be tested in a step 440. In some embodiments, an ohm meter may be used to test the circuit. In a non-limiting example, the two white wires may be connected to an ohm meter. In the present non-limiting example, the ohm meter may be set to 20K ohms. The black wires may be configured to be non-touching. In the present non-limiting example, the ohm meter may show approximately 2.0K ohms. In another non-limiting example, an alligator clip may be used to short the two black wires together. In the present non-limiting example, the ohm meter may show approximately 1.0K ohms when an alligator clip may be used to short the two black wires together. In the present embodiment, embodiments of the present invention may be packaged in a step 445. In a non-limiting example, embodiments of the present invention may be bundled in packs of ten or any other amount. In some embodiments, rubber bands or other joining means may be used to bundle embodiments of the present invention together. In a non-limiting example, embodiments of the present invention may be placed in a bag approximately 5″×7″ inches in size.

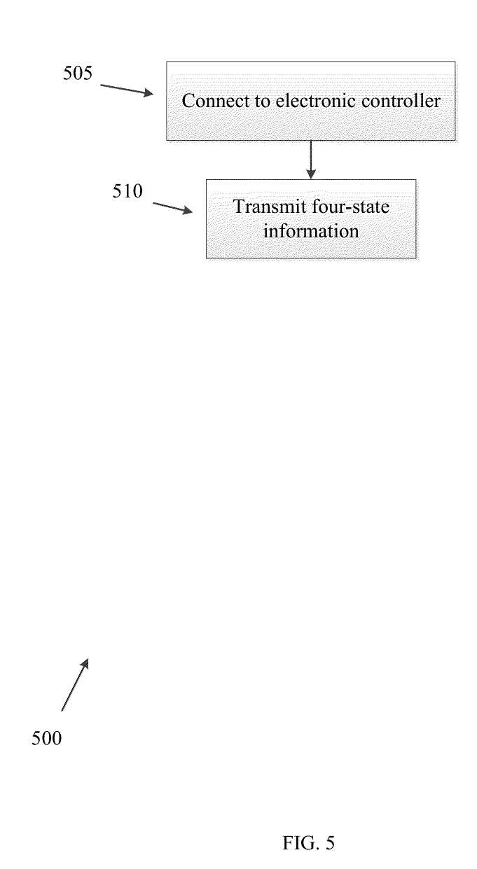

FIG. 5 is an illustration of a method for using an apparatus for easing installation of electronic devices, in accordance with an embodiment of the present invention. Embodiments of the present invention may include a method 500 for the apparatus to wire to a monitoring system. In the present non-limiting example, embodiments may be wired to an electronic access control device in a step 505. Embodiments may also be used in connection with various other devices, including, without limitation, panic buttons, unlock buttons, door release buttons, motion detectors, temperature sensors, glassbreak sensors, water detectors, and any other form of signaling equipment an end user may wish to monitor with a security system. Some embodiments may be wired up in series-parallel or parallel-series, depending on a system's operational requirements. Embodiments may be installed at the end of line, meaning as close to a signaling device as possible. In the present non-limiting example, embodiments may be used to transmit information for four different states which may be controlled by the electronic access control device in a step 510. In alternative embodiments, any number of wires may be used to transmit information for any number of different states.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing electronic wiring according to the present invention will be apparent to those skilled in the art. Various aspects of the invention have been described above by way of illustration, and the specific embodiments disclosed are not intended to limit the invention to the particular forms disclosed. The particular implementation of the electronic wiring may vary depending upon the particular context or application. By way of example, and not limitation, the electronic wiring described in the foregoing were principally directed to monitoring system implementations; however, similar techniques may instead be applied to non-monitoring systems, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a first set of wires;
a first resistor, said first resistor being disposed to join with said first set of wires;
a second set of wires;
a second resistor, said second resistor being disposed to join with said second set of wires; and
a tube, said tube being configured to join said first resistor and said first set of wires with said second resistor and said second set of wires, said joined wires and resistors comprising a unitary circuit.

2. The apparatus of claim 1, in which said unitary circuit comprises a predetermined Ohm value, said predetermined Ohm value comprising 1 kiliohm or 2 kiliohm.

3. The apparatus of claim 1, in which said unitary circuit comprises at least one directional wire.

4. The apparatus of claim 1, wherein said unitary circuit is operable to be tested.

5. The apparatus of claim 1, wherein said testing comprises joining said unitary circuit with an Ohm meter.

6. The apparatus of claim 1, wherein said unitary circuit is disposed to join with a monitoring system.

7. The apparatus of claim 1, in which said first set of wires comprises a first black wire, said first set of wires further comprising a first gray wire.

8. The apparatus of claim 1, in which said second set of wires comprises a second black wire, said second set of wires further comprising a second gray wire.

9. The apparatus of claim 1, in which a first resistor symbol comprises a first resistor.

10. The apparatus of claim 1, in which a second resistor symbol comprises a second resistor.

11. The apparatus of claim 1, in which a first wire symbol comprises a first gray wire.

12. The apparatus of claim 1, in which a second wire symbol comprises second gray wire.

13. The apparatus of claim 1, in which a third wire symbol comprises a first black wire.

14. The apparatus of claim 1, in which a fourth wire symbol comprises a second black wire.

15. The apparatus of claim 1, in which said tube comprises a cylinder encasement configured to at least partially join pre-twisted wires.

16. The apparatus of claim 1, in which said tube comprises a shrink tube, said shrink tube being configured to at least partially join said first set of wires with said first resistor and/or said second set of wires with said second resistor.

17. The apparatus of claim 16, in which said tube further comprises a hard tube, said hard tube being configured to at least partially cover said shrink tube.

18. The apparatus of claim 17, in which said tube further comprises a labeled shrink tube, said labeled shrink tube being configured to at least partially cover said hard tube.

19. An apparatus comprising:
means for cutting at least one wire;
means for connecting at least one resistor to said at least one wire;
means for joining a shrink tube to said at least one resistor;
means for joining a hard tube to said shrink tube;
means for twisting said at least one wire together;
means for joining a labeled shrink tube to said hard tube;
means for shortening and pre-stripping said at least one wire;
means for testing a unitary circuit;
means for packaging an apparatus;
means for joining said apparatus to an electronic controller; and
means for transmitting four-state information.

20. The apparatus of claim 19, in which said at least one wire comprises at least four wires, said apparatus further comprising a first wire symbol comprising a first gray wire, a second wire symbol comprising second gray wire, a third wire symbol comprising a first black wire, and a fourth wire symbol comprising a second black wire.

21. An apparatus consisting of:
a first set of wires, said first set of wires comprising a first black wire, said first set of wires further comprising a first gray wire;
a first resistor, said first resistor being disposed to join with said first set of wires, said first resistor comprising an Ohm value of 1 kilohm and/or 2 kiliohm;
a second set of wires, said second set of wires comprising a second black wire, said second set of wires further comprising a second gray wire;
a second resistor, said second resistor being disposed to join with said second set of wires; and
a tube, said tube comprising a shrink tube, said shrink tube being configured to at least partially join said first set of wires with said first resistor and/or said second set of wires with said second resistor, said tube further comprising a hard tube, said hard tube being configured to at least partially cover said shrink tube, said tube further comprising a labeled shrink tube, said labeled shrink tube being configured to at least partially cover said hard tube, said tube being configured to join said first resistor and said first set of wires with said second resistor and said second set of wires, said joined wires and resistors comprising a unitary circuit.
